(19) United States
(12) Patent Application Publication
(10) Pub. No.: US 2026/0253790 A1
(43) Pub. Date: Aug. 27, 2026

(54) COIL COMPONENT AND ELECTRONIC/ELECTRIC DEVICE

(71) Applicant: DELTA ELECTRONICS (JAPAN), INC., Tokyo (JP)

(72) Inventors: Taishi NUMATA, Tokyo (JP); Yoshitaka UTO, Tokyo (JP); Akinori KOJIMA, Tokyo (JP); Keiichi ARAKI, Tokyo (JP); Satoshi MARUYAMA, Tokyo (JP)

(73) Assignee: DELTA ELECTRONICS (JAPAN), INC., Tokyo (JP)

(21) Appl. No.: 19/647,869

(22) Filed: Apr. 14, 2026

Related U.S. Application Data
(63) Continuation of application No. PCT/JP2023/037638, filed on Oct. 18, 2023.

(51) Int. Cl. H01F 27/28; H01F 27/00; H01F 27/255; H01F 27/29; H01F 30/06

(52) U.S. Cl. CPC H01F 27/2828; H01F 27/006; H01F 27/255; H01F 27/292; H01F 30/06

(57) ABSTRACT

A coil component having a coil with a shape capable of increasing overall characteristic L×Isat/DCR of the coil component includes: a coil member having a spiral conductor portion (first spiral conductor portion) having a plurality of turns with a central axis along a first direction, and a lead-out conductor portion (first lead-out portion) extending in a second direction (X1-X2 direction) intersecting the first direction (Z1-Z2 direction) from an outer-side end part of the spiral conductor portion; and a core main body portion that includes magnetic powder and a binder, covers the spiral conductor portion and the lead-out conductor portion, and from which an end surface (first lead-out portion end surface) of the lead-out conductor portion is exposed, wherein two side surfaces (lead-out portion inner-side surface, lead-out portion outer-side surface) along the second direction in the lead-out conductor portion have a non-parallel portion when viewed in the first direction.

### CROSS REFERENCE TO RELATED APPLICATIONS

This application is a continuation application of PCT Application No. PCT/JP2023/037638, filed on Oct. 18, 2023. The content of the application is incorporated herein by reference.

### BACKGROUND OF THE INVENTION

### 1. Field of the Invention

The present invention relates to a coil component and an electronic/electric device, in which the coil component is installed.

### 2. Description of the Related Art

Patent Document 1 discloses an electronic component including: a coil fixed body having at least one coil pattern layer in which at least a part of a coil pattern is formed on one plane by a conductor, and at least one insulating resin layer stacked with the coil pattern layer and formed of an insulating resin, wherein a coil is formed by at least one layer of the coil pattern layer, and the coil pattern layer is fixed by the insulating resin; and a magnetic body portion formed of a composite magnetic material obtained by mixing magnetic material particles and a resin and curing the mixture so as to cover the coil fixed body except for terminal portions.

### PRIOR ART DOCUMENT

### Patent Document

[Patent Document 1] Japanese Patent Publication No. 2015-126198

### SUMMARY OF THE INVENTION

### Problems to be Solved by the Invention

The coil included in a coil component 900 according to Patent Document 1 described above has a structure as shown in FIG. 14A. A terminal pattern 913b is formed at one end of a spiral first coil pattern 913a so as to connect the coil pattern to an external terminal 914. As shown in FIG. 14B, which is a partially enlarged view of FIG. 14A, in the vicinity of a connection portion between the terminal pattern 913b and the first coil pattern 913a, the direction in which current flows is greatly bent, and therefore, there is a tendency for a direct current resistance value DCR (unit: mΩ) to locally increase in this portion.

Further, as shown in FIG. 14B, an induced magnetic field Mia based on a current flowing through the first coil pattern 913a along a virtual conductive center line Lfa and an induced magnetic field Mib based on a current flowing through the terminal pattern 913b along a virtual conductive center line Lfb strengthen or weaken each other, thereby forming locations where magnetic field strength locally differs. Specifically, in a region R1 indicated by a broken line, the magnetic field strength becomes relatively high, and in a region R2 indicated by a broken line, the magnetic field strength becomes relatively low. Such variation in magnetic field strength causes fluctuation in the self-inductance L (unit: μH) of the coil component 900, and further affects a rated current for direct current superposition Isat (unit: A). As a result, a negative effect is exerted on an overall characteristic of the coil component 900, namely L×Isat/DCR (unit: mH·A·Ω⁻¹). In the present specification, the rated current for direct current superposition Isat means a current value at which the self-inductance L decreases by 30% when direct current is superposed.

An object of the present invention is to provide a coil component having a coil with a shape capable of minimizing adverse effects on the coil component caused by the shape of a coil pattern and the shape of a terminal pattern connected to the coil, and capable of increasing the overall characteristic L×Isat/DCR of the coil component, and to provide an electronic/electric device in which the coil component is mounted.

### Means to Solve the Problems

In one aspect of the present invention, a coil component is provided to solve the above problems. The coil component includes: a coil member including a spiral conductor portion having a plurality of turns with a central axis along a first direction, and a lead-out conductor portion extending in a second direction intersecting the first direction from an outer-side end part of the spiral conductor portion; and a core main body portion that includes a magnetic powder and a binder, and covers the spiral conductor portion and the lead-out conductor portion with an end surface of the lead-out conductor portion exposed therefrom, wherein two side surfaces of the lead-out conductor portion along the second direction have a non-parallel portion when viewed in the first direction.

Accordingly, interference between a magnetic field generated from the spiral conductor portion (coil pattern) and a magnetic field generated from the lead-out conductor portion (terminal pattern) can be reduced, and properties of the coil component can be improved. In addition, bending of a current flow from the spiral conductor portion to the lead-out conductor portion (the same applies to a current flow from the lead-out conductor portion to the spiral conductor portion; the same applies hereinafter) is reduced, contributing to a reduction in direct current resistance value DCR.

In the above-described coil component, the lead-out conductor portion may have a portion with a width becoming larger as approaching a boundary with the spiral conductor portion. Accordingly, reduction of interference between the magnetic field generated from the spiral conductor portion and the magnetic field generated from the lead-out conductor portion is stably achieved, and the bending of the current flow from the spiral conductor portion to the lead-out conductor portion also tends to become gentle.

In the above-described coil component, when viewed in the first direction, a tangent line drawn from a midpoint of a line formed by the end surface of the lead-out conductor portion to an inner periphery of an outermost turn among the plurality of turns may overlap the outermost turn and the lead-out conductor portion from a contact point thereof to the midpoint. Accordingly, reduction of interference between the magnetic field generated from the spiral conductor portion and the magnetic field generated from the lead-out conductor portion is more stably achieved, and the bending of the current flow from the spiral conductor portion to the lead-out conductor portion also tends to become more gentle.

In the above-described coil component, when viewed in the first direction, a tangent line is drawn from the midpoint of the line formed by the end surface of the lead-out conductor portion to the inner periphery of the outermost turn among the plurality of turns, and, from a contact point of the tangent line to the midpoint, a clearance from the tangent line to a point closest thereto on a line formed by an outer peripheral side surface of the outermost turn and a side surface of the lead-out conductor portion continuous with the outer peripheral side surface may be not less than one quarter and not more than three quarters of a width passing through the contact point in the outermost turn. Accordingly, reduction of interference between the magnetic field generated from the spiral conductor portion and the magnetic field generated from the lead-out conductor portion is achieved particularly stably, and the bending of the current flow from the spiral conductor portion to the lead-out conductor portion also tends to become particularly gentle. Moreover, it is possible to suppress an effect of reduction in self-inductance L caused by an increase in the width of the outermost turn and the width of the lead-out conductor portion, and the overall characteristic L×Isat/DCR of the coil component can be easily increased.

In the above-described coil component, when viewed in the first direction, a tangent line is drawn from the midpoint of the line formed by the end surface of the lead-out conductor portion to the inner periphery of the outermost turn among the plurality of turns, and a portion of the inner periphery of the outermost turn from a contact point of the tangent line to an end on the lead-out conductor portion side is approximated by an arc. Meanwhile, a line segment connecting a center of the arc and the midpoint may be parallel to a side surface of the lead-out conductor portion that is connected to the inner periphery of the outermost turn. Accordingly, reduction of interference of the magnetic field in the vicinity of a connection portion between the lead-out conductor portion and the spiral conductor portion is achieved particularly stably. Moreover, it is possible to suppress an effect of reduction in self-inductance L caused by an increase in the width of the lead-out conductor portion, and the overall characteristic L×Isat/DCR of the coil component can be easily increased.

In the above-described coil component, when viewed in the first direction, a tangent line is drawn from the midpoint of the line formed by the end surface of the lead-out conductor portion to the inner periphery of the outermost turn among the plurality of turns. A first line obtained by connecting an outer peripheral side end point of a width passing through a contact point of the tangent line and an outer peripheral side end point of a line formed by the end surface of the lead-out conductor portion may have a portion positioned on an inner peripheral side relative to an outer periphery of the outermost turn. Accordingly, reduction of interference of the magnetic field in the vicinity of a connection portion between the lead-out conductor portion and the spiral conductor portion is achieved particularly stably. Moreover, it is possible to suppress an effect of reduction in self-inductance L caused by an increase in the width of the lead-out conductor portion, and the overall characteristic L×Isat/DCR of the coil component can be easily increased. When viewed in the first direction, a portion positioned on an outer peripheral side relative to the first line on a line formed by an outer peripheral side surface of the outermost turn and a side surface of the lead-out conductor portion continuous with the outer peripheral side surface is defined as an outer peripheral side portion. If a clearance from the first line to a farthest point to the first line in the outer peripheral side portion is not less than one tenth of the width passing through the contact point in the outermost turn, the overall characteristic L×Isat/DCR of the coil component can be made particularly high.

The above-described coil component may have at least one of the following features when viewed in the first direction.
(A) A tangent line is drawn from a midpoint of a line formed by the end surface of the lead-out conductor portion to an inner periphery of an outermost turn positioned at the outermost periphery among the plurality of turns, and in a line formed by an outer peripheral side surface of the outermost turn, a portion closer to the end surface of the lead-out conductor portion than an outer peripheral side end point of a width passing through a contact point of the tangent line has a shape approximated by an arc having a center on an inner peripheral side.
(B) When the outer-side end part extends along a width that includes a point at which a virtual conductive center line obtained by connecting midpoints of widths of an outermost turn positioned at the outermost periphery among the plurality of turns and the lead-out conductor portion bends most, an outer peripheral side end point of a line formed by the outer-side end part overlaps with an outer peripheral side end point of the outermost turn on a line formed by the exposed end surface of the lead-out conductor portion.
(C) A tangent line is drawn from a midpoint of a line formed by the end surface of the lead-out conductor portion to an inner periphery of an outermost turn positioned at the outermost periphery among the plurality of turns, and when a side surface of the lead-out conductor portion continuous with an outer peripheral side surface of the outermost turn is defined as a lead-out portion outer-side surface, a point closest to the tangent line on a line formed by the outer peripheral side surface of the outermost turn and the lead-out portion outer-side surface overlaps with an outer peripheral side end point of the outermost turn on a line formed by the exposed end surface of the lead-out conductor portion.

The above-described coil component may further comprise an external electrode provided on the core main body portion and electrically connected to the end surface of the lead-out conductor portion exposed from the core main body portion.

In another aspect of the present invention, an electronic/electric device in which the above-described coil component is mounted is provided. The coil component is connected to a substrate by the external electrode. Examples of such an electronic/electric device include a power supply device provided with a power supply switching circuit, a voltage step-up/step-down circuit, a smoothing circuit, or the like, and a small portable communication device. Since the electronic/electric device according to the present invention includes the above-described coil component, it is excellent in terms of quality and dimensions.

### Effects of the Invention

According to the present invention, there are provided a coil component, and an electronic/electric device in which the coil component is mounted. The coil component includes a coil with a shape capable of minimizing adverse effects on the coil component caused by the shape of a coil pattern and the shape of a terminal pattern connected to the coil, and capable of increasing an overall characteristic L×Isat/DCR of the coil component.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a perspective view conceptually illustrating the shape of a coil component according to an embodiment of the present invention.

FIG. 2 is a view for illustrating the structure of a coil conductor portion included in a coil component according to an embodiment of the present invention.

FIG. 3 is an XY plan view for illustrating the structure of the coil conductor portion included in the coil component according to an embodiment of the present invention.

FIG. 4 is an XZ cross-sectional view taken along line A-A′ of FIG. 2.

FIG. 5 is a partially enlarged view of FIG. 3 for illustrating the structure in the vicinity of an outer-side end part of the coil conductor portion and a lead-out end portion.

FIG. 6A is a view for illustrating the structure of a coil conductor portion of a coil component according to a comparative example.

FIG. 6B is a partially enlarged view of FIG. 6A.

FIG. 7A is a view for illustrating the structure of a coil conductor portion of a coil component according to an exemplified embodiment of the present invention (Embodiment 1).

FIG. 7B is a partially enlarged view of FIG. 7A.

FIG. 8A is a view for illustrating the structure of a coil conductor portion of a coil component according to an embodiment of one embodiment of the present invention (Embodiment 2).

FIG. 8B is a partially enlarged view of FIG. 8A.

FIG. 9A is a view for illustrating the structure of a coil conductor portion of a coil component according to an exemplified embodiment of the present invention (Embodiment 3).

FIG. 9B is a partially enlarged view of FIG. 9A.

FIG. 10A is a view for illustrating the structure of a coil conductor portion of a coil component according to an exemplified embodiment of the present invention (Embodiment 4).

FIG. 10B is a partially enlarged view of FIG. 10A.

FIG. 11A is a view for illustrating the structure of a coil conductor portion of a coil component according to an exemplified embodiment of the present invention (Embodiment 5).

FIG. 11B is a partially enlarged view of FIG. 11A.

FIG. 12A is a view for illustrating the structure of a coil conductor portion of a coil component according to an exemplified embodiment of the present invention (Embodiment 6).

FIG. 12B is a partially enlarged view of FIG. 12A.

FIG. 13A is a view for illustrating the structure of a coil conductor portion of a coil component according to an exemplified embodiment of the present invention (Embodiment 7).

FIG. 13B is a partially enlarged view of FIG. 13A.

FIG. 14A is a view for illustrating the structure of a coil component according to the related art.

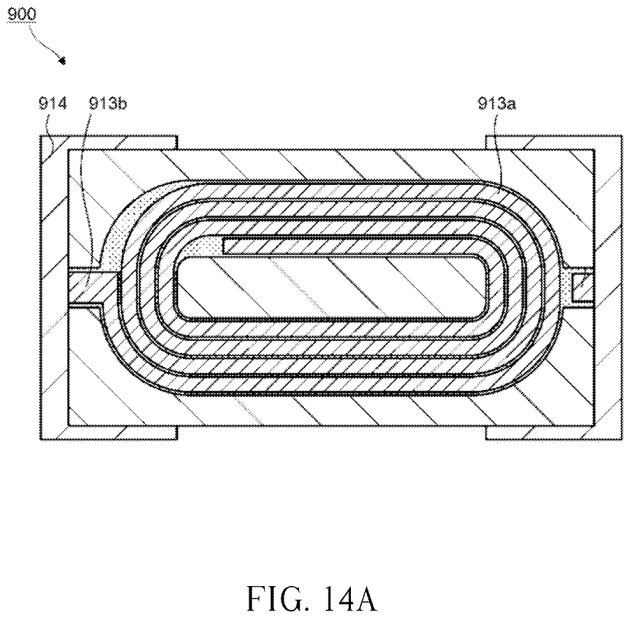

FIG. 14B is a partially enlarged view of FIG. 14A.

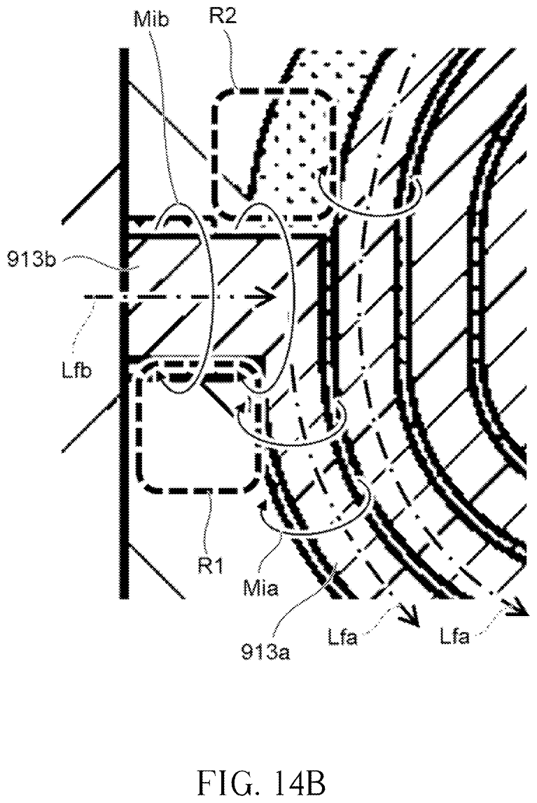

### DETAILED DESCRIPTION

Hereinafter, embodiments of the present invention will be described in detail with reference to the drawings.

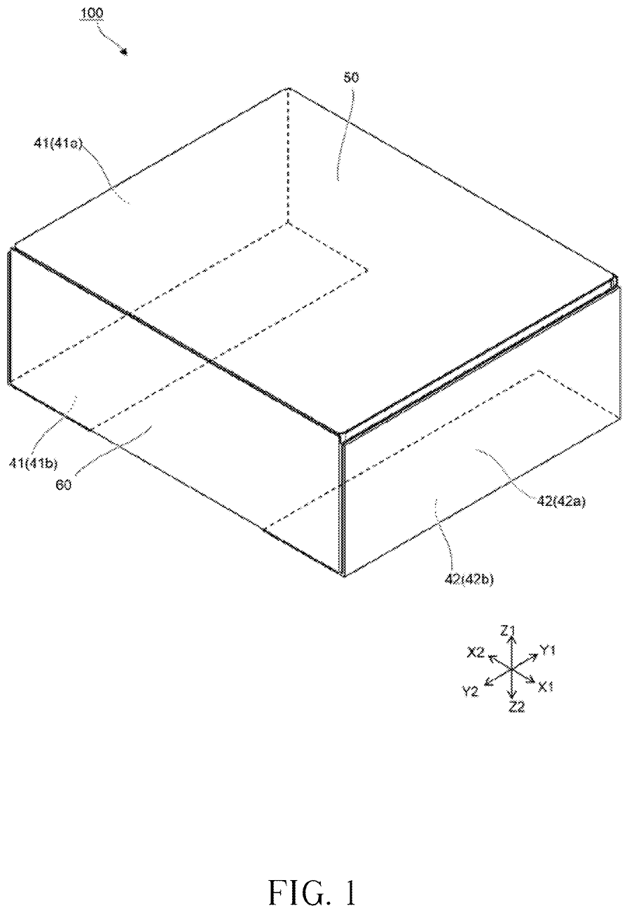

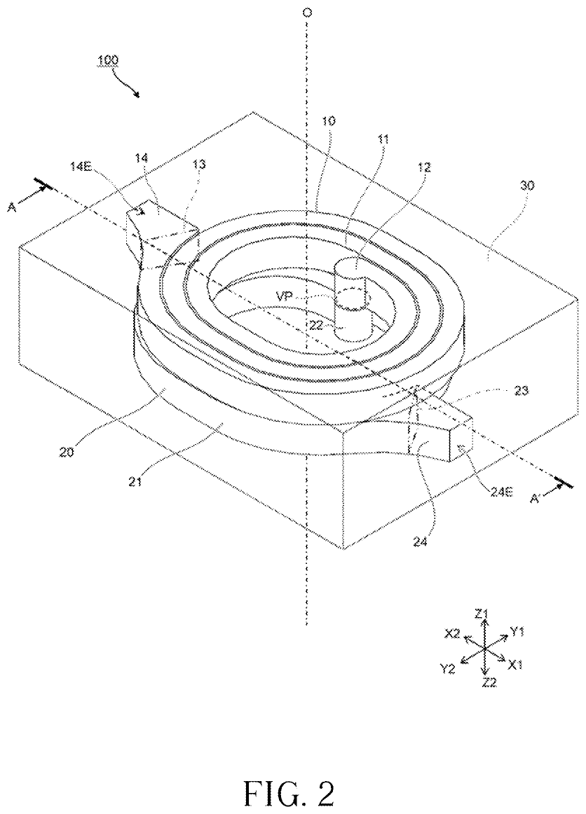

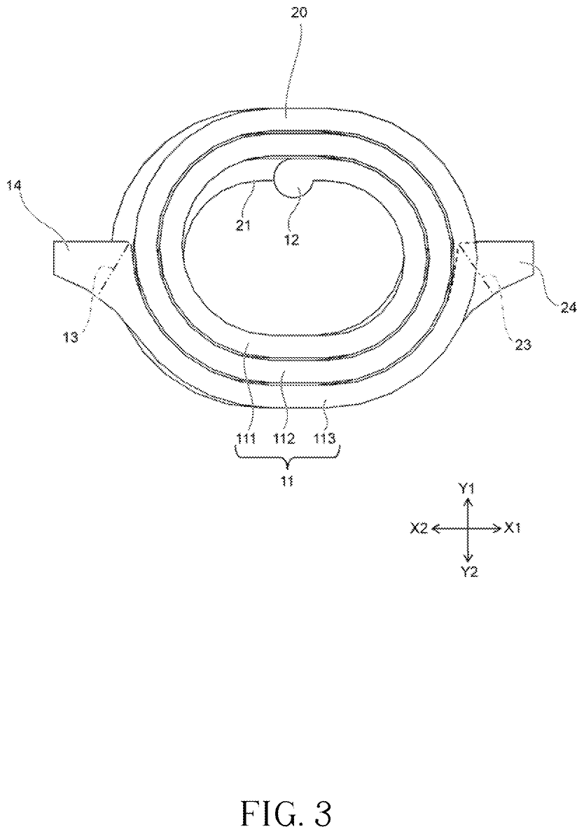

FIG. 1 is a perspective view conceptually illustrating the shape of a coil component according to an embodiment of the present invention. FIG. 2 is a view for illustrating the structure of a coil conductor portion included in the coil component according to an embodiment of the present invention. In FIG. 2, for convenience of explanation, the coil conductor portion is drawn with solid lines, the core main body portion is drawn with dotted lines, and illustration of other constituent elements is omitted. Further, line A-A′ in FIG. 2 is a line that passes through the center of the coil component in the Y1-Y2 direction and is parallel to the X1-X2 direction. FIG. 3 is an XY plan view for illustrating the structure of the coil conductor portion included in the coil component according to an embodiment of the present invention.

### (Overall Configuration)

A coil component 100 according to an embodiment of the present invention includes a coil member 10 having a coil conductor portion 20, a core main body portion 30, a first external electrode 41, a second external electrode 42, and outer covers 50 and 60.

### (Coil)

As shown in FIG. 2 and FIG. 3, the coil member 10 includes a coil conductor portion 20 including a first spiral conductor portion 11 having a spiral shape that extends around a central axis O along a first direction (Z1-Z2 direction) and spirals away from the central axis O from an inner-side end part 12, which is an end part on an inner peripheral side of the first spiral conductor portion 11, toward an outer-side end part 13, which is an end part on an outer peripheral side of the first spiral conductor portion 11. In FIG. 2, the first spiral conductor portion 11 is arranged such that, when viewed from the Z1 side in the Z1-Z2 direction, the conductor is disposed in a spiral shape that spirals away from the central axis O in a clockwise direction from the inner-side end part 12 toward the outer-side end part 13. In the present specification, the “spiral direction” in the first spiral conductor portion 11 means a direction from the inner-side end part 12 toward the outer-side end part 13. The same applies to a second spiral conductor portion 21 described later.

The conductor (conductive material) constituting the coil conductor portion 20 is not particularly limited as long as it has appropriate conductivity. Metals such as copper, copper alloys, aluminum, and aluminum alloys may be given as specific examples of the conductor constituting the coil conductor portion 20, and the coil conductor portion 20 can be manufactured using a film-forming technique such as plating, for example. The coil member 10 has an insulating coil insulator portion (not illustrated in FIG. 1 to FIG. 3) on the surface of the coil conductor portion 20. By this coil insulator portion, insulation is ensured between adjacent conductors in the coil conductor portion 20 (between surfaces of conductors facing each other). The coil insulator portion is composed of, for example, a resin material. The coil insulator portion is not provided at terminal ends of two end portions as the coil conductor portion 20 (a first lead-out portion end surface 14E and a second lead-out portion end surface 24E), and the coil member 10 can be electrically connected to other members at these terminal ends.

As shown in FIG. 2, the coil conductor portion 20 has a second spiral conductor portion 21 arranged alongside the first spiral conductor portion 11 in the first direction. The second spiral conductor portion 21 has a spiral shape that extends around the central axis O along the first direction (Z1-Z2 direction) and spirals away from the central axis O from an inner-side end part 22, which is an end part on an inner peripheral side of the second spiral conductor portion 21, toward an outer-side end part 23, which is an end part on an outer peripheral side of the second spiral conductor portion 21. In the second spiral conductor portion 21, when viewed from the Z1 side in the Z1-Z2 direction, the conductor is arranged in a spiral shape that spirals away from the central axis O in a direction opposite to that of the first spiral conductor portion 11 (counterclockwise in FIG. 2). The average value of a clearance in the first direction (Z1-Z2 direction) between the first spiral conductor portion 11 and the second spiral conductor portion 21 is not particularly limited. The smaller this clearance is, the easier it is to reduce the height (dimension in Z1-Z2 direction) of the coil component 100; however, if it is excessively small, the insulation between the first spiral conductor portion 11 and the second spiral conductor portion 21 tends to decrease. From the viewpoint of achieving both a low profile (low height) of the coil component 100 and high insulation between the first spiral conductor portion 11 and the second spiral conductor portion 21, the clearance is preferably 0.4 μm or more and 20 μm or less in some cases. From a manufacturing viewpoint, in order to reduce variation in the clearance and to more reliably support the coil in the same plane, the clearance is more preferably 1.0 μm or more, and further preferably 5.0 μm or more.

The inner-side end part 12 of the first spiral conductor portion 11 and the inner-side end part 22 of the second spiral conductor portion 21 are electrically connected by a via portion VP. The via portion VP may be composed of the same conductor as the coil conductor portion 20. In one specific example, the via portion VP is made of the same material as the first spiral conductor portion 11 and the second spiral conductor portion 21, and is manufactured simultaneously with the first spiral conductor portion 11 and the second spiral conductor portion 21. In this case, the via portion VP is integrated with the inner-side end part 12 of the first spiral conductor portion 11 and the inner-side end part 22 of the second spiral conductor portion 21.

A first lead-out portion 14 is continuously provided at the outer-side end part 13 of the first spiral conductor portion 11, and a second lead-out portion 24 is continuously provided at the outer-side end part 23 of the second spiral conductor portion 21. Therefore, the outer-side end part 13 of the first spiral conductor portion 11 is substantially a boundary with the first lead-out portion 14, and the outer-side end part 23 of the second spiral conductor portion 21 is substantially a boundary with the second lead-out portion 24. In one specific example, the first lead-out portion 14 and the second lead-out portion 24 are made of the same material as the first spiral conductor portion 11 and the second spiral conductor portion 21, and are manufactured simultaneously with the first spiral conductor portion 11 and the second spiral conductor portion 21. In this case, the first lead-out portion 14 is integrated with the outer-side end part 13 of the first spiral conductor portion 11, and the second lead-out portion 24 is integrated with the outer-side end part 23 of the second spiral conductor portion 21.

In other words, in the present embodiment, the coil conductor portion 20 includes the first spiral conductor portion 11, the second spiral conductor portion 21, the via portion VP, the first lead-out portion 14, and the second lead-out portion 24, which are formed from a common conductive material. As a result, the coil conductor portion 20 has a conductive path that extends from the outer-side end part 13 of the first spiral conductor portion 11, passes through the first spiral conductor portion 11 to reach the inner-side end part 12, then reaches the inner-side end part 22 of the second spiral conductor portion 21 via the via portion VP that is in contact with the inner-side end part 12, and then passes through the second spiral conductor portion 21 from the inner-side end part 22 to reach the outer-side end part 23 of the second spiral conductor portion 21.

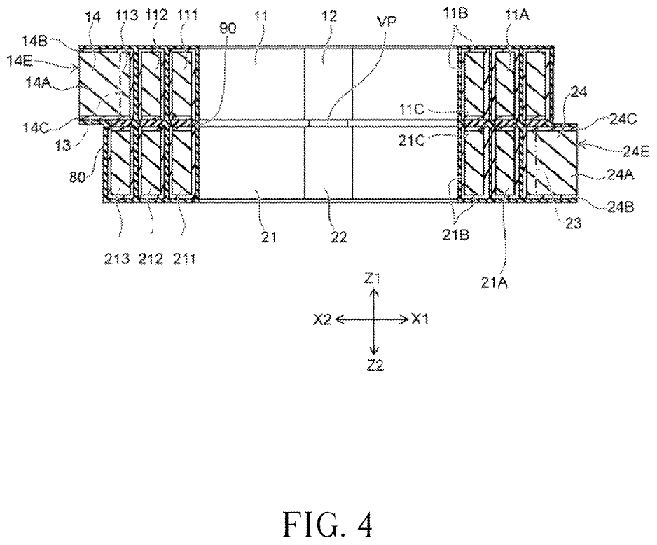

FIG. 4 is an XZ cross-sectional view (an XZ cross-sectional view) for illustrating the structure of the coil member included in the coil component according to an embodiment of the present invention, wherein the XZ plane is a plane indicated by line A-A′ of FIG. 2. In FIG. 4, elements other than the coil member 10 are not shown.

As also shown in the cross sections of FIG. 3 and FIG. 4, each turn of the first spiral conductor portion 11 and each turn of the second spiral conductor portion 21 are positioned so as to be arranged in the first direction. The first spiral conductor portion 11 includes a first innermost turn 111, which is a turn positioned at the innermost periphery, a first outermost turn 113, which is a turn positioned at the outermost periphery, and a first middle turn 112, which is a turn positioned between these turns. The second spiral conductor portion 21 includes a second innermost turn 211, which is a turn positioned at the innermost periphery, a second outermost turn 213, which is a turn positioned at the outermost periphery, and a second middle turn 212, which is a turn positioned between these turns.

The second innermost turn 211 is positioned on the Z2 side in the Z1-Z2 direction of the first innermost turn 111, the second outermost turn 213 is positioned on the Z2 side in the Z1-Z2 direction of the first outermost turn 113, and the second middle turn 212 is positioned on the Z2 side in the Z1-Z2 direction of the first middle turn 112. In the coil member 10 shown in FIG. 4, the second lead-out portion 24 does not exist on the Z2 side in the Z1-Z2 direction at the outer-side end part 13 of the first spiral conductor portion 11, and the first lead-out portion 14 does not exist on the Z1 side in the Z1-Z2 direction at the outer-side end part 23 of the second spiral conductor portion 21.

### (First Conductor Portion, Second Conductor Portion)

As shown in FIG. 4, the first spiral conductor portion 11 includes a first conductor portion 11A that extends along a conductive path from the outer-side end part 13 of the first spiral conductor portion 11 to the outer-side end part 23 of the second spiral conductor portion 21 via the via portion VP and is made of a first conductive material, and a second conductor portion 11B that is made of a second conductive material and covers at least a part of the first conductor portion 11A.

As described later, in one example, the first conductor portion 11A and the second conductor portion 11B are manufactured by different manufacturing processes. In this case, even if they are made of materials of the same type (for example, materials containing Cu, e.g., Cu or Cu alloys), they can be distinguished by cross-sectional observation or the like because organizational features such as crystal structure, crystal orientation, and crystal growth direction differ. In one specific example, the first conductor portion 11A is made of an electroplated deposit (electrolytic plating deposit), and the second conductor portion 11B is made of a plating deposit. At this time, the plating deposit may be an electroplated deposit or an electroless plating deposit. From the viewpoint of improving controllability of the thickness of the second conductor portion 11B, it may be preferable that the plating deposit be an electroplated deposit.

In the present embodiment, a third conductor portion 11C as shown in FIG. 4 is provided at an end portion of the first conductor portion 11A on a side (Z2 side in Z1-Z2 direction) facing the second spiral conductor portion 21 in the first direction (Z1-Z2 direction). The third conductive material constituting the third conductor portion 11C is not limited. It may be of the same type as the material constituting the first conductor portion 11A (for example, materials containing Cu, e.g., Cu or Cu alloys), or may be different. From a manufacturing viewpoint (as a base film for electroplating), it may be preferable that the third conductor portion 11C be made of a material containing at least one of Ni and Cr. It may be preferable that the material constituting the first conductor portion 11A and the material constituting the third conductor portion 11C have different etching properties. For example, when the first conductor portion 11A is made of Cu and the third conductor portion 11C is made of Ni, it is possible to etch Ni with high selectivity depending on etching conditions. The third conductor portion 11C may be in the form of a film, or may be constituted by a laminated film of different materials.

Similarly to the first spiral conductor portion 11, the second spiral conductor portion 21 includes a first conductor portion 21A that extends along a conductive path and is made of the first conductive material, and a second conductor portion 21B that is made of the second conductive material and covers at least a part of the first conductor portion 21A. In the present embodiment, the second spiral conductor portion 21 further includes a third conductor portion 21C (see FIG. 4) made of a third conductive material at an end portion of the first conductor portion 21A on a side (Z1 side in Z1-Z2 direction) facing the first spiral conductor portion 11 in the first direction (Z1-Z2 direction).

As shown in FIG. 4, the first lead-out portion 14 and the second lead-out portion 24 also include a first conductor portion 14A, 24A, a second conductor portion 14B, 24B, and a third conductor portion 14C, 24C, similarly to the first spiral conductor portion 11 and the second spiral conductor portion 21. That is, the first conductor portions 14A, 11A, 21A, and 24A extend along the conductive path of the coil conductor portion 20 from the first lead-out portion end surface 14E to the second lead-out portion end surface 24E via the first lead-out portion 14, the first spiral conductor portion 11, the via portion VP, the second spiral conductor portion 21, and the second lead-out portion 24.

### (Structure Near Outer-Side End Part of Coil Conductor Portion and Lead-Out End Portion)

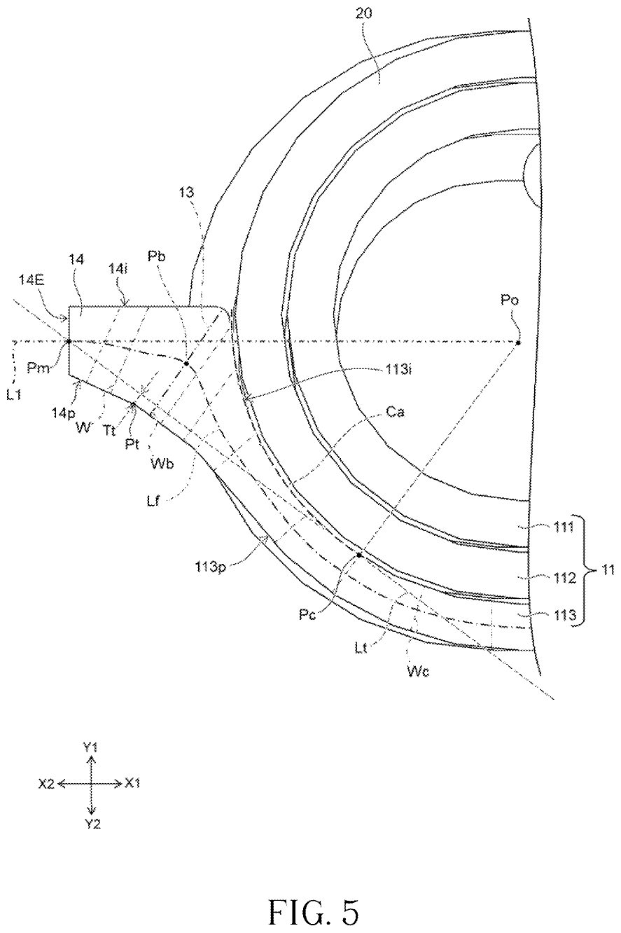

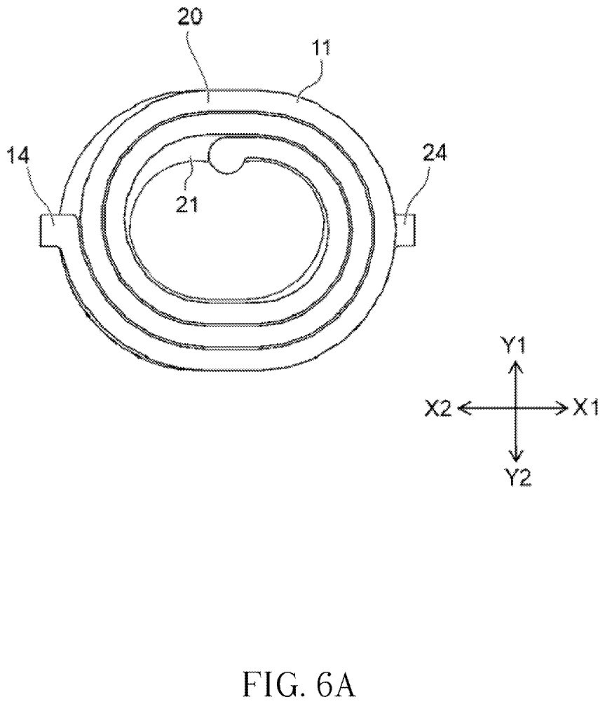

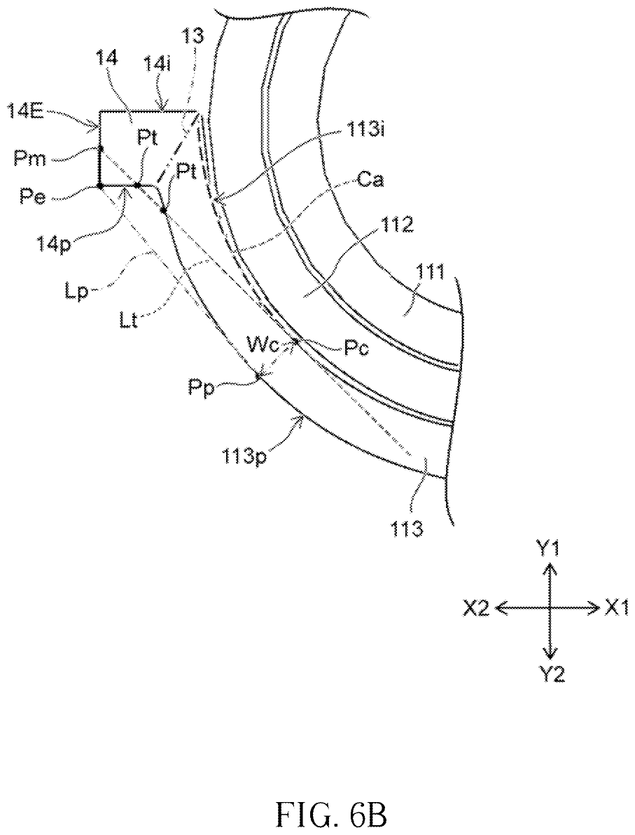

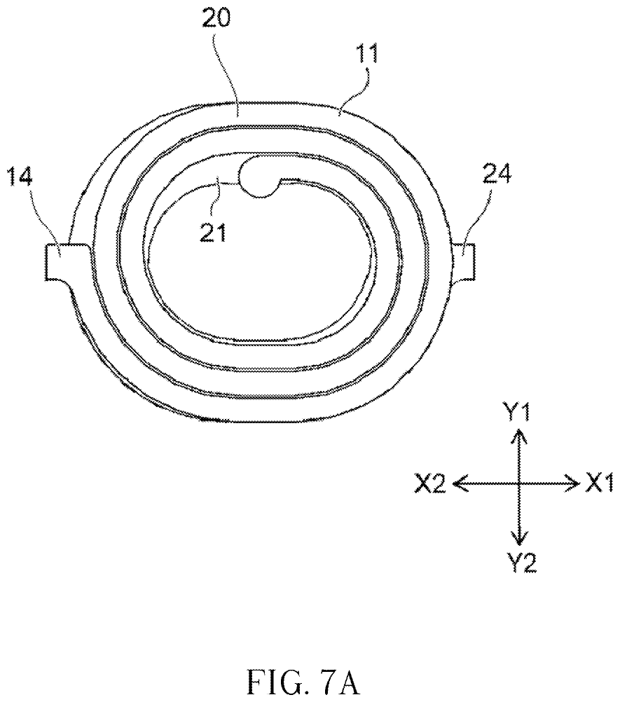

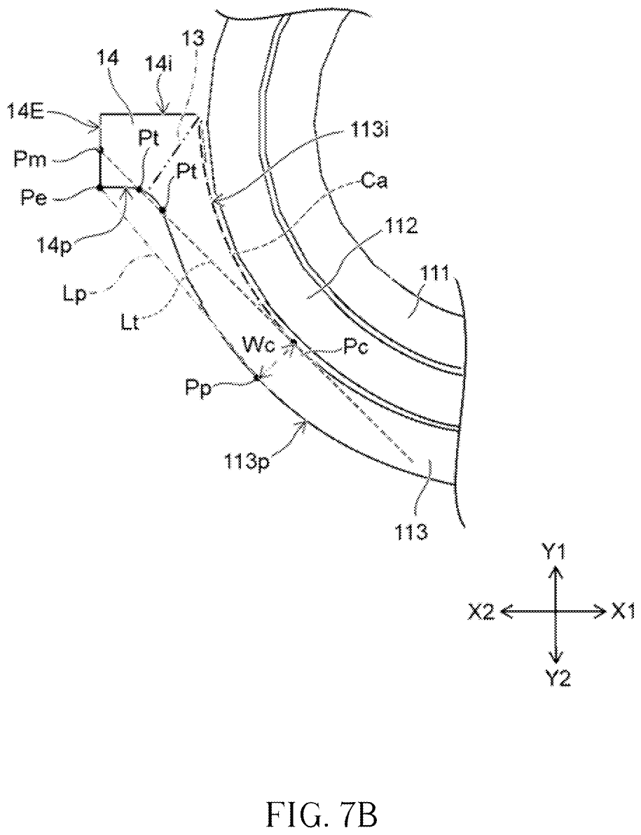

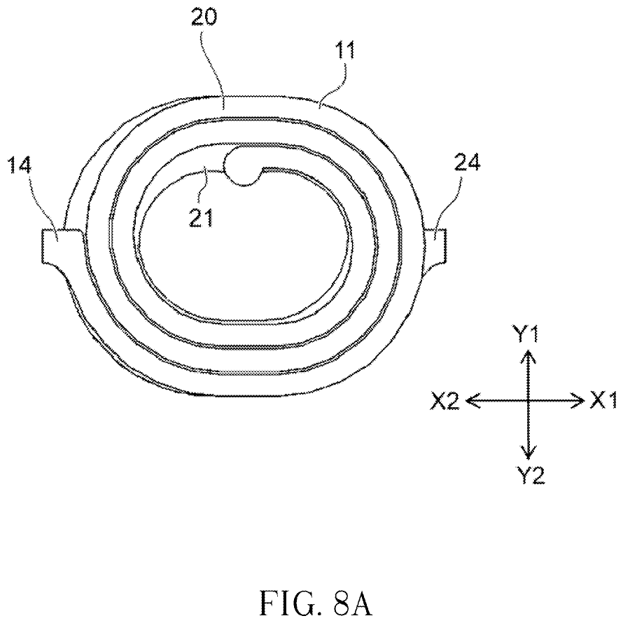

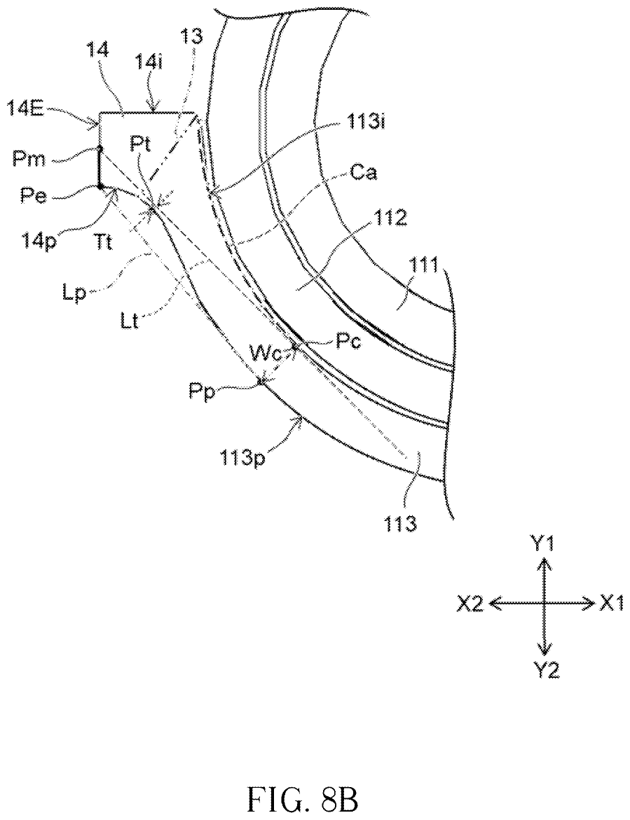

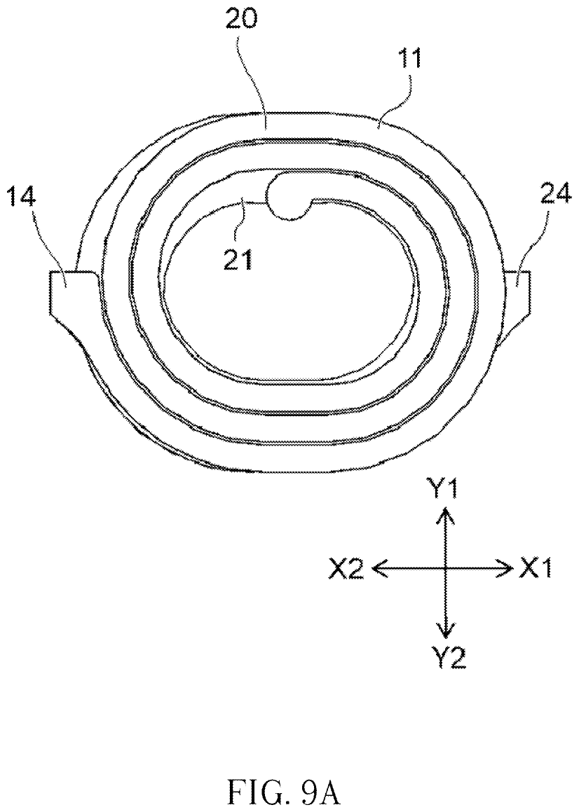

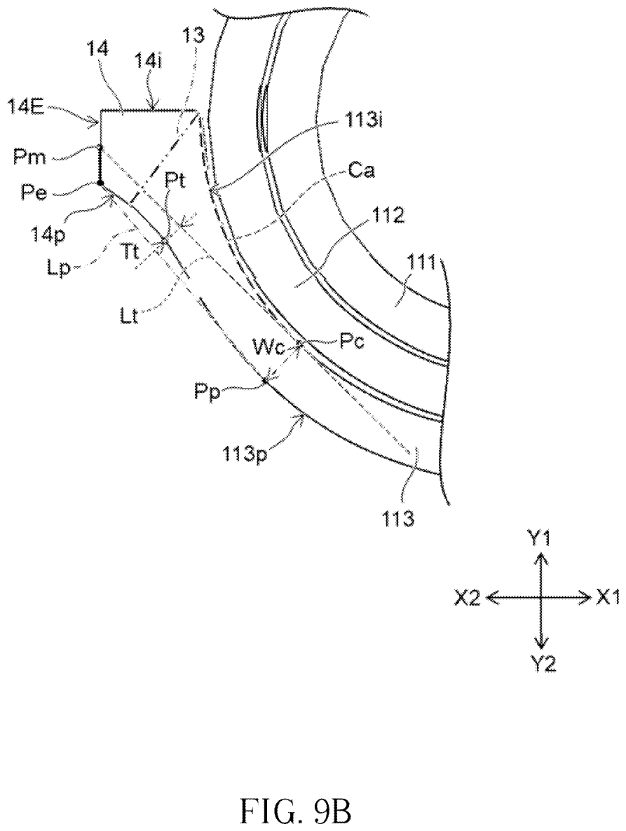

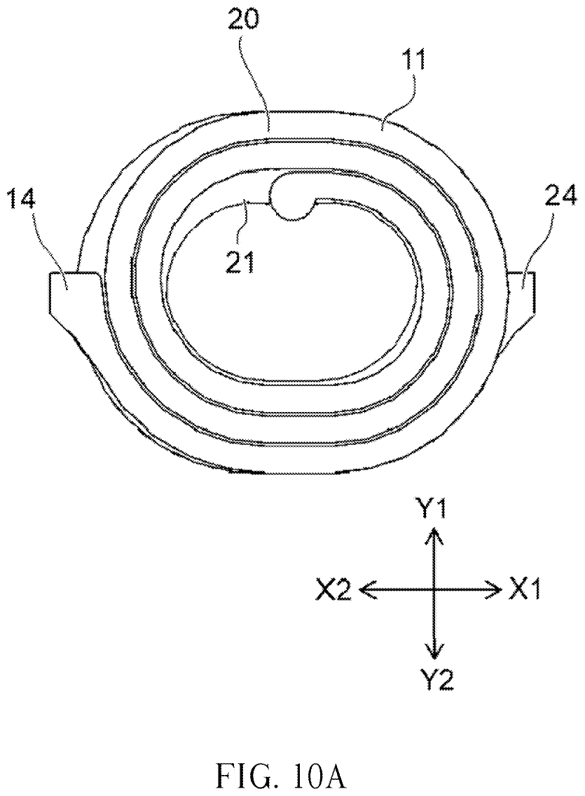

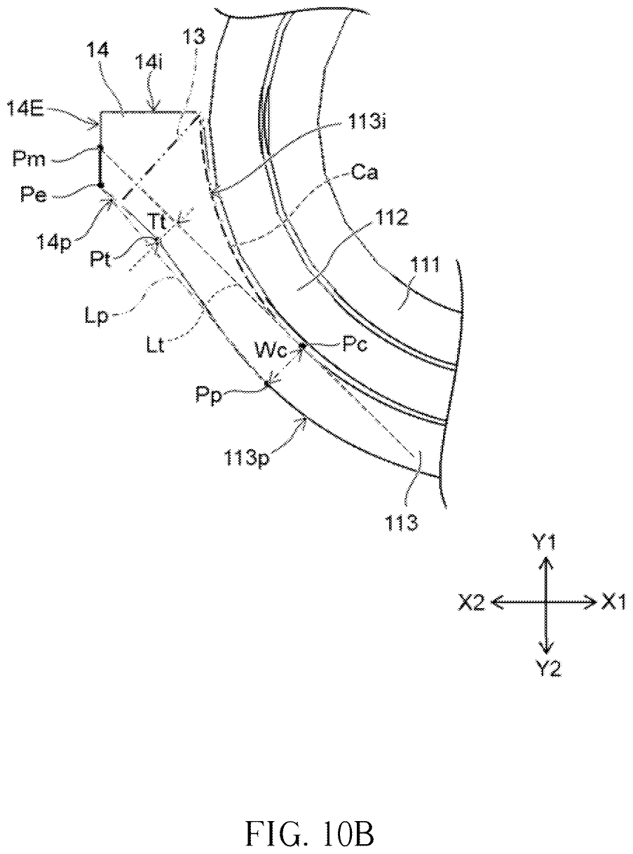

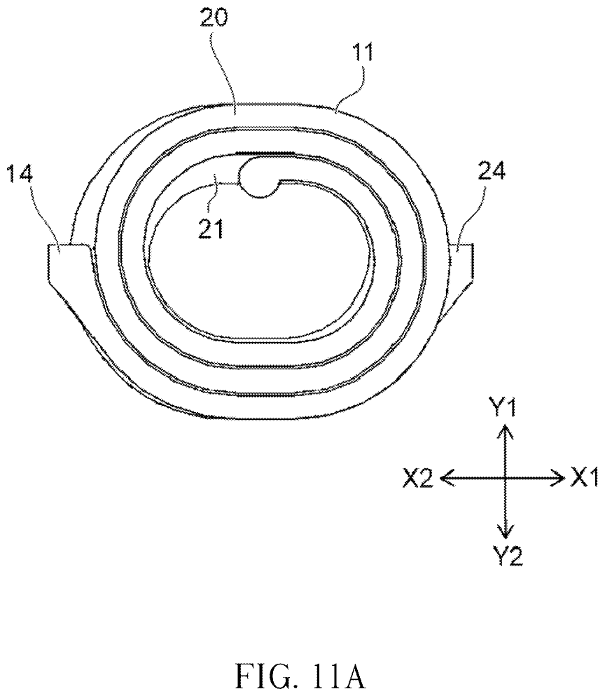

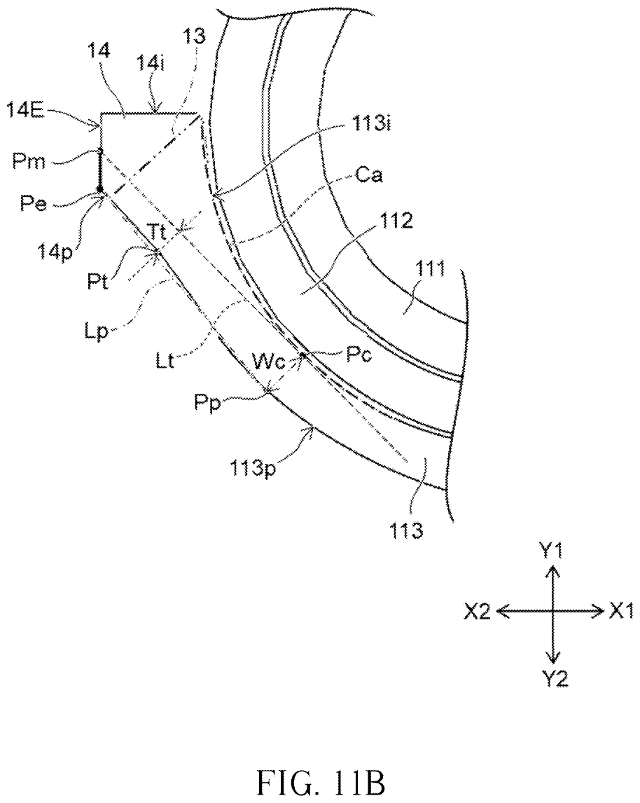

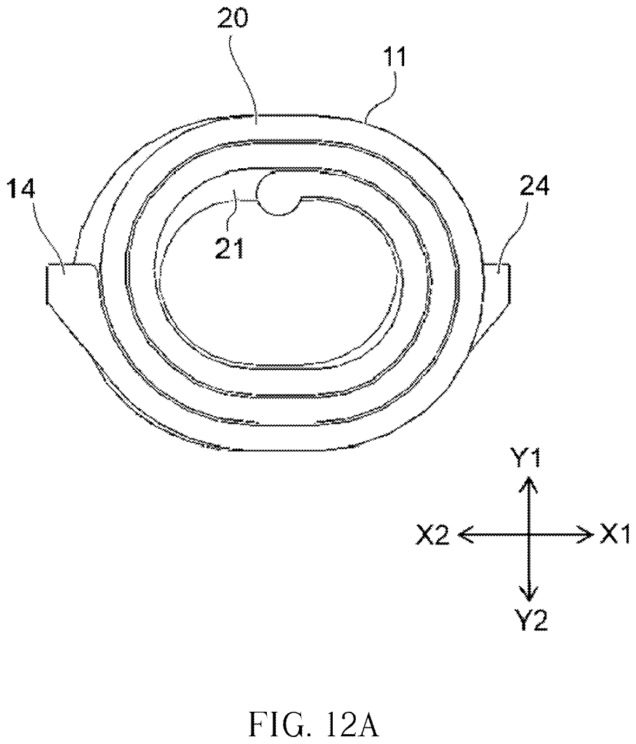

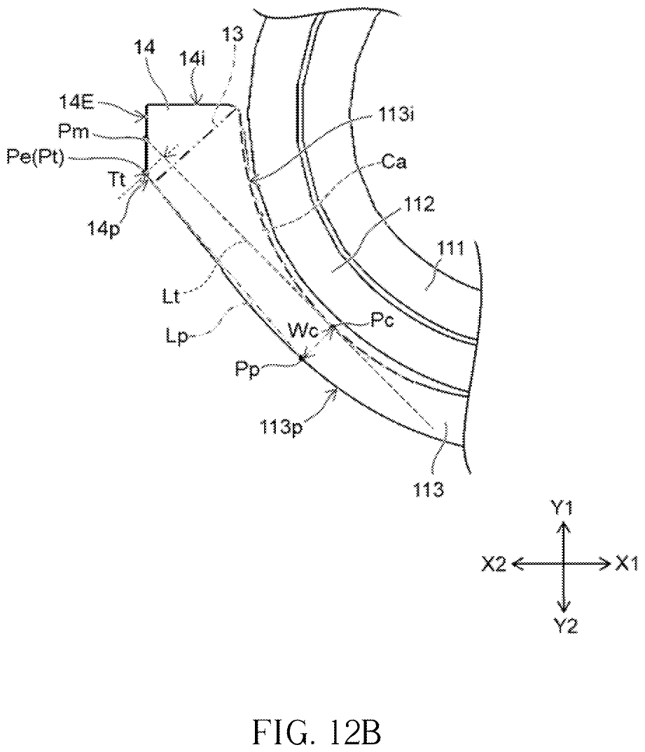

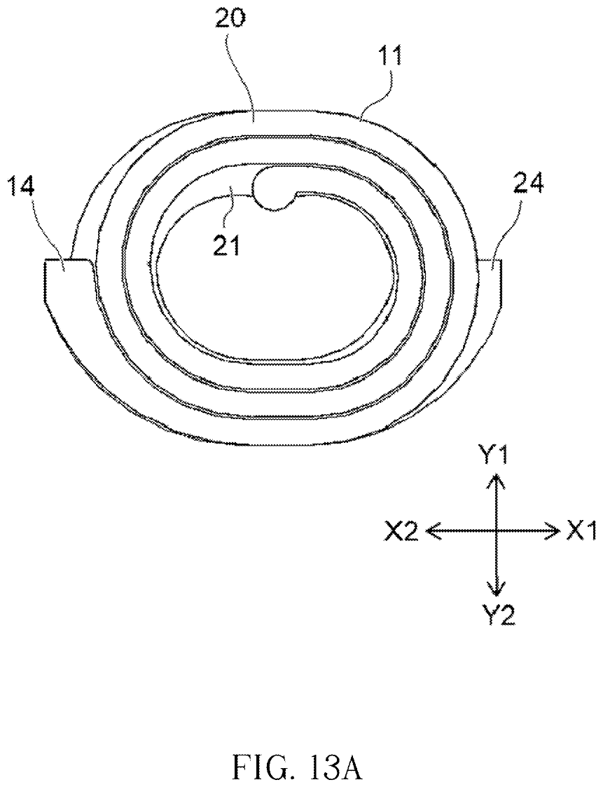

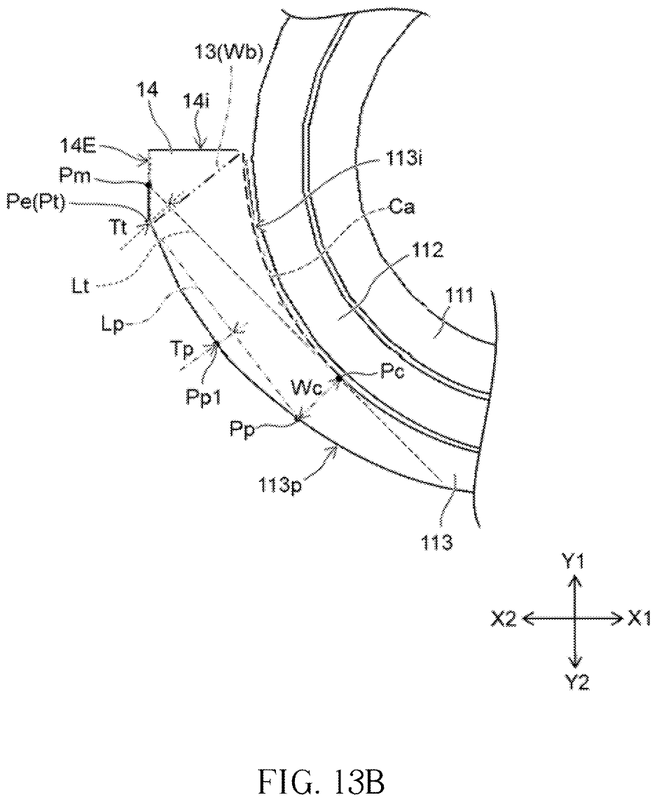

FIG. 5 is a partially enlarged view of FIG. 3 on the X2 side in the X1-X2 direction, and is a view for illustrating the structure in the vicinity of the outer-side end part of the coil conductor portion and the lead-out end portion. FIG. 6A is a view for illustrating the structure of the coil conductor portion of a coil component according to a comparative example, and FIG. 6B is a partially enlarged view of FIG. 6A on the X2 side in the X1-X2 direction and on the Y2 side in the Y1-Y2 direction. FIG. 7A is a view for illustrating the structure of the coil conductor portion of a coil component according to an example (Embodiment 1) of an embodiment of the present invention, and FIG. 7B is a partially enlarged view of FIG. 7A on the X2 side in the X1-X2 direction and on the Y2 side in the Y1-Y2 direction. FIG. 8A is a view for illustrating the structure of the coil conductor portion of a coil component according to an example (Embodiment 2) of an embodiment of the present invention, and FIG. 8B is a partially enlarged view of FIG. 8A on the X2 side in the X1-X2 direction and on the Y2 side in the Y1-Y2 direction. FIG. 9A is a view for illustrating the structure of the coil conductor portion of a coil component according to an example (Embodiment 3) of an embodiment of the present invention, and FIG. 9B is a partially enlarged view of FIG. 9A on the X2 side in the X1-X2 direction and on the Y2 side in the Y1-Y2 direction. FIG. 10A is a view for illustrating the structure of the coil conductor portion of a coil component according to an example (Embodiment 4) of an embodiment of the present invention, and FIG. 10B is a partially enlarged view of FIG. 10A on the X2 side in the X1-X2 direction and on the Y2 side in the Y1-Y2 direction. FIG. 11A is a view for illustrating the structure of the coil conductor portion of a coil component according to an example (Embodiment 5) of an embodiment of the present invention, and FIG. 11B is a partially enlarged view of FIG. 11A on the X2 side in the X1-X2 direction and on the Y2 side in the Y1-Y2 direction. FIG. 12A is a view for illustrating the structure of the coil conductor portion of a coil component according to an example (Embodiment 6) of an embodiment of the present invention, and FIG. 12B is a partially enlarged view of FIG. 12A on the X2 side in the X1-X2 direction and on the Y2 side in the Y1-Y2 direction. FIG. 13A is a view for illustrating the structure of the coil conductor portion of a coil component according to an example (Embodiment 7) of an embodiment of the present invention, and FIG. 13B is a partially enlarged view of FIG. 13A on the X2 side in the X1-X2 direction and on the Y2 side in the Y1-Y2 direction.

The coil conductor portion 20 according to the comparative example shown in FIG. 6A and FIG. 6B, and the coil conductor portions 20 according to Embodiment 1 to Embodiment 7 shown in FIG. 7A to FIG. 13B, all have a common shape of the first spiral conductor portion 11 and the second spiral conductor portion 21, and differ in the shape of the first lead-out portion 14 and the shape of the second lead-out portion 24. In any of the examples, the shape of the first lead-out portion 14 and the shape of the second lead-out portion 24 are identical. The shape characteristics of each example will be collectively described later in the explanation of simulation results.

### (Definition of Width and Outer-Side End Part)

First, a width W of the coil conductor portion 20 is defined with reference to FIG. 5. In the coil conductor portion 20 shown in FIG. 5, the first lead-out portion 14 includes a lead-out portion inner-side surface 14i, which is a side surface continuous with an inner peripheral side surface 113i of the first outermost turn 113 and is positioned on a Y1 side in the Y1-Y2 direction, and a lead-out portion outer-side surface 14p, which is a side surface continuous with an outer peripheral side surface 113p of the first outermost turn 113 and is positioned on a Y2 side in the Y1-Y2 direction. When viewed in the first direction, since the lead-out portion inner-side surface 14i is longer than the lead-out portion outer-side surface 14p, the width W is defined from the side of the lead-out portion inner-side surface 14i.

Specifically, when viewed in the first direction, a point on a line formed by the lead-out portion inner-side surface 14i is identified, and a point on a line formed by the lead-out portion outer-side surface 14p that is closest to the point on the lead-out portion inner-side surface 14i is identified. A line segment obtained by connecting these points is defined as a width W at that point. The width W is indicated by a two-dot chain line in FIG. 5. The width W according to this definition is specified from an end point, on a side of the first lead-out portion end surface 14E, of the line formed by the lead-out portion inner-side surface 14i, along the line formed by the lead-out portion inner-side surface 14i toward an X1 side in the X1-X2 direction, and is further set along a line formed by the inner peripheral side surface 113i (inner periphery) of the first outermost turn 113.

After the width W is thus set for the first lead-out portion 14 and the first outermost turn 113, midpoints of the widths W as viewed in the first direction are connected to obtain a virtual conductive center line Lf. The virtual conductive center line Lf is a line extending along a direction in which current most easily flows in the coil conductor portion 20 when the coil component 100 is energized, and is indicated by a thick one-dot chain line in FIG. 5. At the first lead-out portion end surface 14E, the virtual conductive center line Lf passes through a midpoint Pm of a line formed by the first lead-out portion end surface 14E when viewed in the first direction. In the present specification, a width Wb passing through a maximum bending point Pb, at which a degree of bending of the virtual conductive center line Lf becomes maximum when viewed in the first direction, is defined as corresponding to a boundary between the first lead-out portion 14 and the first outermost turn 113, that is, corresponding to an outer-side end part 13 of the first spiral conductor portion 11. Accordingly, end points of the width Wb passing through the maximum bending point Pb are, when viewed in the first direction, respectively a boundary between the inner peripheral side surface 113i of the first outermost turn 113 and the lead-out portion inner-side surface 14i, and a boundary between the outer peripheral side surface 113p of the first outermost turn 113 and the lead-out portion outer-side surface 14p.

### (First Feature)

In the coil conductor portion 20 included in the coil component 100 according to the present embodiment, as a first feature, two side surfaces (lead-out portion inner-side surface 14i and lead-out portion outer-side surface 14p) extending along a second direction (X1-X2 direction) intersecting a first direction (Z1-Z2 direction) in a lead-out conductor portion, which is the first lead-out portion 14, have a non-parallel portion when viewed in the first direction. Specifically, as shown in FIG. 5, both the lead-out portion inner-side surface 14i and the lead-out portion outer-side surface 14p are side surfaces extending along the X1-X2 direction, but the lead-out portion inner-side surface 14i is substantially parallel to the X1-X2 direction, whereas the lead-out portion outer-side surface 14p is inclined such that the X1 side is inclined toward the Y2 side in the Y1-Y2 direction relative to the X1-X2 direction. Therefore, the lead-out portion inner-side surface 14i and the lead-out portion outer-side surface 14p are non-parallel.

In this manner, the lead-out portion inner-side surface 14i and the lead-out portion outer-side surface 14p have a non-parallel portion, and specifically have a portion in which the width W becomes larger as approaching the outer-side end part 13, which is a boundary with the first spiral conductor portion 11.

By the coil conductor portion 20 having such a structure, interference between a magnetic field generated from the first spiral conductor portion 11 and a magnetic field generated from the first lead-out portion 14 can be reduced, and properties of the coil component 100 can be improved. In addition, since the outer-side end part 13 has the maximum bending point Pb of the virtual conductive center line Lf, it is a portion where electron flow is likely to be locally disturbed when current is supplied to the coil component 100. However, in the coil conductor portion 20, since the width Wb at the outer-side end part 13 is relatively widened, disturbance of electron flow is less likely to lead to an increase in resistance value. Therefore, a direct current resistance value DCR is less likely to increase, and coil properties of the coil component 100 are less likely to deteriorate.

As shown in FIG. 6B, in the coil conductor portion 20 according to the comparative example, the lead-out portion inner-side surface 14i and the lead-out portion outer-side surface 14p are parallel to each other. In contrast, as shown in FIGS. 7B to 13B, in the coil conductor portions 20 according to the examples, the lead-out portion inner-side surface 14i and the lead-out portion outer-side surface 14p are non-parallel. In the coil conductor portion 20 according to Embodiment 1 shown in FIG. 7B, the portion where the lead-out portion inner-side surface 14i and the lead-out portion outer-side surface 14p are non-parallel is only a very small portion in the vicinity of the outer-side end part 13. On the other hand, in the coil conductor portion 20 according to Embodiment 7 shown in FIG. 13B, an outer peripheral side end point of the width Wb of the outer-side end part 13 is positioned at an outer peripheral side end point Pe of a line formed by the first lead-out portion end surface 14E, and therefore the lead-out portion outer-side surface 14p does not exist. Accordingly, in Embodiment 7, the lead-out portion inner-side surface 14i and the lead-out portion outer-side surface 14p are non-parallel because the lead-out portion outer-side surface 14p does not exist.

### (Second Feature)

Next, a first tangent line Lt of the coil conductor portion 20 is defined. The first tangent line Lt is a tangent line drawn to an inner periphery of a first outermost turn 113, which is an outermost turn among a plurality of turns included in the first spiral conductor portion 11, from a midpoint Pm of a line formed by the first lead-out portion end surface 14E, when viewed in the first direction. The first tangent line Lt is indicated by a broken line in FIG. 5.

In the coil conductor portion 20 of the coil component 100 according to the present embodiment, as a second feature, when viewed in the first direction, the first tangent line Lt overlaps both the first outermost turn 113 and the first lead-out portion 14, which is a lead-out conductor portion, over an entirety between a contact point Pc with the inner periphery of the first outermost turn 113 and the midpoint Pm.

In this case, interference between a magnetic field generated from the first spiral conductor portion 11 and a magnetic field generated from the first lead-out portion 14 can be reduced, and improvement of properties of the coil component 100 can be stably achieved. In addition, since a conductive material exists over the entirety between the midpoint Pm and the contact point Pc, when current is supplied to the coil component 100, electrons can move between the midpoint Pm and the contact point Pc without detouring. Therefore, in the coil conductor portion 20, resistance value is less likely to increase on an outer peripheral side relative to the contact point Pc. Accordingly, the direct current resistance value DCR is less likely to increase, and coil characteristics of the coil component 100 are less likely to deteriorate.

As shown in FIG. 6B, in the coil conductor portion 20 according to the comparative example, the first tangent line Lt intersects with a line formed by the lead-out portion outer-side surface 14p and/or a line formed by an outer peripheral side surface 113p of the first outermost turn 113. Therefore, the first tangent line Lt has a portion that does not overlap the first outermost turn 113 and the first lead-out portion 14, when viewed in the first direction, between the contact point Pc with the inner periphery of the first outermost turn 113 and the midpoint Pm. As shown in FIG. 7B, in the coil conductor portion 20 according to Embodiment 1, the first tangent line Lt does not intersect with the line formed by the lead-out portion outer-side surface 14p, but intersects with the line formed by the outer peripheral side surface 113p of the first outermost turn 113. Therefore, the coil conductor portion 20 according to Embodiment 1 does not have the second feature. On the other hand, the coil conductor portions 20 according to Embodiments 2 to 7 have the second feature.

### (Third Feature)

In the coil conductor portion 20 of the coil component 100 according to the present embodiment, as a third feature, when viewed in the first direction, a clearance Tt from the first tangent line Lt to a closest point Pt on a line formed by the outer peripheral side surface 113p of the first outermost turn 113 and the lead-out portion outer-side surface 14p continuous with the outer peripheral side surface 113p satisfies that the clearance Tt is not less than one quarter and not more than three quarters of a width Wc passing through the contact point Pc.

In this case, reduction of interference between a magnetic field generated from the first spiral conductor portion 11 and a magnetic field generated from the first lead-out portion 14 can be achieved particularly stably, and bending of current flow from the first spiral conductor portion 11 to the first lead-out portion 14 also tends to become particularly gentle. Moreover, it is possible to suppress an effect of reduction in self-inductance L caused by an increase in the width W of the first outermost turn 113 and the width of the first lead-out portion 14, and the overall characteristic L×Isat/DCR of the coil component 100 tends to become high.

In the coil conductor portion 20 according to the comparative example (FIG. 6B) and Embodiment 1 (FIG. 7B), since the first tangent line Lt intersects with a line formed by the lead-out portion outer-side surface 14p and/or a line formed by the outer peripheral side surface 113p of the first outermost turn 113 when viewed in the first direction, this intersection becomes the closest point Pt, and therefore the clearance Tt described above is not defined. On the other hand, in the coil conductor portions 20 according to Embodiment 2 (FIG. 8B) to Embodiment 7 (FIG. 13B), when viewed in the first direction, the first tangent line Lt intersects with neither a line formed by the lead-out portion outer-side surface 14p nor a line formed by the outer peripheral side surface 113p of the first outermost turn 113, and therefore the clearance Tt is set. In the coil conductor portion 20 according to Embodiment 2 (FIG. 8B), the clearance Tt is less than one quarter of the width Wc passing through the contact point Pc, whereas in the coil conductor portions 20 according to Embodiment 3 (FIG. 9B) to Embodiment 7 (FIG. 13B), the clearance Tt satisfies being not less than one quarter and not more than three quarters of the width Wc passing through the contact point Pc, and thus has the third feature. In the coil conductor portions 20 according to Embodiment 6 (FIG. 12B) and Embodiment 7 (FIG. 13B), the closest point Pt overlaps with an outer peripheral side end point Pe of a line formed by the first lead-out portion end surface 14E.

### (Fourth Feature)

In the coil conductor portion 20 of the coil component 100 according to the present embodiment, as a fourth feature, when viewed in the first direction, when a portion of a line (inner periphery) formed by the inner peripheral side surface 113i of the first outermost turn 113 from the contact point Pc to an end on the first lead-out portion 14 is approximated by an arc Ca, a line segment L1 (indicated by a one-dot chain line in FIG. 5) connecting a center Po of the arc Ca and the midpoint Pm is parallel to a side surface (the lead-out portion inner-side surface 14i) of the first lead-out portion 14 connected to the inner periphery of the first outermost turn 113. As a result, reduction of interference of a magnetic field in the vicinity of a connection portion between the first lead-out portion 14 and the first spiral conductor portion 11 can be achieved particularly stably. Moreover, it is possible to suppress an effect of reduction in self-inductance L caused by widening of the width of the first lead-out portion 14, and the overall characteristic L×Isat/DCR of the coil component 100 can be easily increased. All of the coil conductor portions 20 according to Embodiment 1 (FIG. 7B) to Embodiment 7 (FIG. 13B) have the fourth feature.

### (Fifth Feature)

In the coil conductor portion 20 of the coil component 100 according to the present embodiment, as a fifth feature, when viewed in the first direction, a first line Lp obtained by connecting an outer peripheral side end point Pp of a width Wc, which passes through the contact point Pc, and an outer peripheral side end point Pe of a line formed by the first lead-out portion end surface 14E may have a portion positioned on an inner peripheral side relative to a line (outer periphery) formed by the outer peripheral side surface 113p of the first outermost turn 113. As a result, reduction of interference of a magnetic field in the vicinity of a connection portion between the first lead-out portion 14 and the first spiral conductor portion 11 can be achieved particularly stably. Moreover, it is possible to suppress an effect of reduction in self-inductance L caused by widening of the width W of the first lead-out portion 14, and the overall characteristic L×Isat/DCR of the coil component 100 can be easily increased.

When a portion positioned on an outer peripheral side relative to the first line Lp on a line formed by the outer peripheral side surface 113p of the first outermost turn 113 and the lead-out portion outer-side surface 14p continuous with the outer peripheral side surface 113p is defined as an outer peripheral side portion, if a clearance Tp from the first line Lp to a farthest point Ppl of the outer peripheral side portion is not less than one tenth of the width Wc passing through the contact point Pc in the first outermost turn 113, the overall characteristic L×Isat/DCR of the coil component 100 can be made particularly high.

Since the coil conductor portions 20 according to the comparative example (FIG. 6B), Embodiment 1 (FIG. 7B), and Embodiment 2 (FIG. 8B) do not have the outer peripheral side portion, the farthest point Ppl is not defined. The coil conductor portions 20 according to Embodiment 3 (FIG. 8B) to Embodiment 7 (FIG. 13B) have the outer peripheral side portion, but in the coil conductor portions 20 according to Embodiment 3 (FIG. 8B) to Embodiment 6 (FIG. 12B), the clearance Tp is extremely short. Therefore, in FIG. 8B to FIG. 12B, the farthest point Ppl and the clearance Tp are not illustrated. In the coil conductor portion 20 according to Embodiment 7 (FIG. 13B), since the first outermost turn 113 has, on a portion closer to the outer-side end part 13 than the contact point Pc, a portion bulging toward an outer peripheral side, the outer peripheral side portion is sufficiently formed, and the clearance Tp is not less than one tenth of the width Wc.

### (Simulation)

Here, shape-related features of the coil conductor portion 20 according to the comparative example (FIG. 6B) and Embodiment 1 (FIG. 7B) to Embodiment 7 (FIG. 13B) are confirmed. In the coil conductor portions 20 according to the comparative example (FIG. 6B) and Embodiment 1 (FIG. 7B) to Embodiment 6 (FIG. 12B), a portion including an outer-peripheral-side end point of a line formed at a boundary between an outer peripheral side surface 113p of the first outermost turn 113 and a lead-out portion outer side surface 14p, that is, a line formed by the outer-side end part 13, when viewed in the first direction, has a shape that can be approximated by an arc having a predetermined radius with a center located on an outer peripheral side, and the radius differs among the respective examples. Specifically, with reference to the coil conductor portion 20 according to the comparative example, this radius is 2.5 times in the coil conductor portion 20 according to Embodiment 1, 5 times in the coil conductor portion 20 according to Embodiment 2, 15 times in the coil conductor portion 20 according to Embodiment 3, 25 times in the coil conductor portion 20 according to Embodiment 4, 50 times in the coil conductor portion 20 according to Embodiment 5, and 250 times in the coil conductor portion 20 according to Embodiment 6.

In the coil conductor portion 20 according to Embodiment 7 (FIG. 13B), which does not have the lead-out portion outer-side surface 14p, unlike the coil conductor portions 20 according to the other examples, when viewed in the first direction, a shape of a portion between an outer peripheral side end point Pe of a line formed by the first lead-out portion end surface 14E on the outer peripheral side surface 113p of the first outermost turn 113 and an outer peripheral side end point Pp of a width Wc passing through the contact point Pc is a shape that can be approximated by an arc having a predetermined radius with a center on an inner peripheral side, and this radius is 30 times with reference to the coil conductor portion 20 according to the comparative example.

Simulations are performed for the coil components 100 according to the comparative example (FIG. 6B) and Embodiment 1 (FIG. 7B) to Embodiment 7 (FIG. 13B), and self-inductance L, a direct current resistance value DCR, and a rated current for direct current superposition Isat are obtained. From these values, an overall characteristic L×Isat/DCR is calculated. The results are shown in Table 1. Table 1 also shows, for each result, a calculated increase rate with reference to the comparative example. In addition, a column of shape-related features in Table 1 shows the above-described multiples of the radius of the approximated arc with reference to the comparative example. Since Embodiment 7 has a different center position of the approximated arc, “*” is attached.

TABLE 1

| | | | | | | Increased rate based | | | |
|---|---|---|---|---|---|---|---|---|---|
| | | | | | L × Isat/ | on comparative example | | | |
| | Shape- | Simulation result | | | DCR | | | | L × |
| | related | L | DCR | Isat | [mH · | | | | Isat/ |
| | feature | [μH] | [mΩ] | [A] | A · Ω⁻¹] | L | DCR | Isat | DCR |
| Comparative | — | 0.360 | 29.99 | 3.60 | 0.0433 | — | — | — | — |
| example | | | | | | | | | |
| Embodiment 1 | 2.5 | 0.360 | 29.94 | 3.61 | 0.0434 | 0.00% | −0.17% | 0.06% | 0.22% |
| Embodiment 2 | 5 | 0.360 | 29.88 | 3.61 | 0.0435 | 0.00% | −0.37% | 0.17% | 0.54% |
| Embodiment 3 | 15 | 0.359 | 29.78 | 3.62 | 0.0436 | −0.28% | −0.70% | 0.33% | 0.76% |
| Embodiment 4 | 25 | 0.359 | 29.75 | 3.62 | 0.0436 | −0.42% | −0.82% | 0.42% | 0.82% |
| Embodiment 5 | 50 | 0.358 | 29.71 | 3.62 | 0.0436 | −0.56% | −0.93% | 0.50% | 0.88% |
| Embodiment 6 | 250 | 0.357 | 29.67 | 3.63 | 0.0436 | −0.83% | −1.07% | 0.61% | 0.85% |
| Embodiment 7 | *30 | 0.353 | 29.27 | 3.67 | 0.0442 | −1.94% | −2.40% | 1.72% | 2.20% |

As shown in Table 1, as a basic tendency, the overall characteristic L×Isat/DCR becomes higher as the embodiment number increases. In Embodiment 7, in which a shape of the outer peripheral side surface 113p of the first outermost turn 113 when viewed in the first direction is a shape approximated by an arc having a center on an inner peripheral side, the overall characteristic L×Isat/DCR becomes particularly high. Embodiment 7 has the following features A to C when viewed in the first direction.
Feature A: In a line formed by the outer peripheral side surface 113p of the first outermost turn 113, a portion closer to the first lead-out portion end surface 14E than an outer peripheral side end point Pp of a width Wc passing through the contact point Pc has a shape approximated by an arc having a center on an inner peripheral side.
Feature B: An outer peripheral side end point of the outer-side end part 13 overlaps with an outer peripheral side end point Pe of a line formed by the first lead-out portion end surface 14E.
Feature C: A closest point Pt to the first tangent line Lt on a line formed by the outer peripheral side surface 113p of the first outermost turn 113 and a lead-out portion outer-side surface 14p continuous with the outer peripheral side surface 113p overlaps with the outer peripheral side end point Pe of the line formed by the first lead-out portion end surface 14E.

Upon closely examining the simulation results, both the self-inductance L and the direct current resistance value DCR are the largest in the comparative example, and tend to become smaller as the embodiment number increases. On the other hand, the rated current for direct current superposition Isat is the smallest in the comparative example, and tends to become larger as the embodiment number increases. Therefore, in the overall characteristic L×Isat/DCR, the influences of the self-inductance L and the direct current resistance value DCR cancel each other out, and it can be said that the overall characteristic L×Isat/DCR generally reflects a tendency of the rated current for direct current superposition Isat.

### (First Insulating Portion)

The coil insulator portion includes a first insulator portion 80, and as shown in FIG. 4, the first insulator portion 80 is provided on at least a part of surfaces of the first spiral conductor portion 11 and the second spiral conductor portion 21.

In the present embodiment, the first insulator portion 80 is thermoplastic, and includes a thermoplastic resin containing a paraxylylene-based polymer. Other examples of the thermoplastic resin include polyethylene, polypropylene, polyamide, polyester, polyamide-imide, polyimide, polysulfone, polycarbonate, liquid crystal polymer, polyvinylidene fluoride, polytetrafluoroethylene, and the like. The first insulator portion 80 only needs to have thermoplasticity as a whole, and may contain, for example, inorganic insulating particles in addition to the above thermoplastic resins.

The first insulator portion 80 preferably has excellent insulating properties. Specifically, in some cases, a volume resistivity obtained by ASTM D257 is preferably 1.0×10¹¹ Ω·cm or more. This volume resistivity is more preferably 1.0×10¹⁵ Ω·cm or more, and further preferably 1.0×10¹⁶ Ω·cm or more. An upper limit of the volume resistivity is not particularly limited, and the volume resistivity may be 1.0×10²⁰ Ω·cm or less. In addition, the first insulator portion 80 preferably has excellent dielectric properties. Specifically, in some cases, a relative dielectric constant at 60 Hz obtained by ASTM D150 is preferably 4.0 or less. This relative dielectric constant is more preferably 3.5 or less, and further preferably 3.0 or less. An upper limit of the relative dielectric constant is not particularly limited, and the relative dielectric constant may be 1.0 or more. Methods for measuring the volume resistivity and the relative dielectric constant of the first insulator portion 80 are not limited as long as results equivalent to those obtained by ASTM D257 and D150 can be expected. For example, a method may be employed in which a measurement sample is separately prepared by adjusting a material corresponding to the first insulator portion 80 to dimensions required for measurement, constituent materials are identified through analytical methods such as component analysis and FT-IR using this measurement sample, and characteristics such as volume resistivity are evaluated for the identified material.

### (Second Insulating Portion)

The coil insulator portion includes a second insulator portion 90, and as shown in FIG. 4, the second insulator portion 90 is in contact with at least one of the first spiral conductor portion 11 and the second spiral conductor portion 21. Accordingly, insulation of the first spiral conductor portion 11 and the second spiral conductor portion 21 is reliably performed. In addition, by the second insulator portion 90 being in contact with both the first spiral conductor portion 11 and the second spiral conductor portion 21 therebetween, short-circuiting between the first spiral conductor portion 11 and the second spiral conductor portion 21 is stably avoided.

A material constituting the second insulator portion 90 is not limited as long as it has appropriate insulating properties. In some cases, the second insulator portion 90 preferably has a volume resistivity obtained by ASTM D257 of 1.0×10¹¹ Ω·cm or more. This volume resistivity is more preferably 1.0×10¹⁵ Ω·cm or more, and further preferably 1.0×10¹⁶ Ω·cm or more. An upper limit of the volume resistivity is not particularly limited, and the volume resistivity may be 1.0×10²⁰ Ω·cm or less. In addition, the second insulator portion 90 preferably has excellent dielectric properties. Specifically, in some cases, a relative dielectric constant at 60 Hz obtained by ASTM D150 is preferably 4.0 or less. This relative dielectric constant is more preferably 3.5 or less, and further preferably 3.0 or less. An upper limit of the relative dielectric constant is not particularly limited, and the relative dielectric constant may be 1.0 or more. Methods for measuring the volume resistivity and the relative dielectric constant of the second insulator portion 90 are not limited as long as results equivalent to those obtained by ASTM D257 and D150 can be expected. For example, a method may be employed in which a measurement sample is separately prepared by adjusting a material corresponding to the second insulator portion 90 to dimensions required for measurement, constituent materials are identified through analytical methods such as component analysis and FT-IR using this measurement sample, and characteristics such as volume resistivity are evaluated for the identified material.

The material constituting the second insulator portion 90 may be an organic material, an inorganic material, or a composite material of an organic material and an inorganic material. When the second insulator portion 90 is made of a composite material, the inorganic material may have a particle shape and be dispersed in a matrix made of the organic material. In this case, the inorganic material may be insulating particles. Specific examples of the organic material include polyimide resins, polyethylene resins, polypropylene resins, polyamide resins, polyester resins, polyamide-imide resins, polysulfone resins, polycarbonate resins, liquid crystal polymer resins, polyvinylidene fluoride resins, polytetrafluoroethylene resins, and the like. Specific examples of the inorganic material, particularly the inorganic material in the composite material, include inorganic materials such as oxides, carbides, nitrides, and inorganic salts. For example, oxides include silica, alumina, and zirconia. In addition, for example, carbides and nitrides include silicon carbide and boron nitride, respectively. Inorganic salts include minerals such as wollastonite, kaolin, and mica. Among these, from the viewpoint of cost and insulating properties, oxide-based materials such as oxides, silicates, and phosphates are preferable. For example, it is preferable that the inorganic material include at least one selected from the group consisting of silicon (Si), phosphorus (P), boron (B), and calcium (Ca).

### (Core Main Body Portion)

The core main body portion 30 includes magnetic powder and encloses a part of the coil member 10. In the present embodiment, the core main body portion 30 has a substantially rectangular parallelepiped shape, and encloses portions other than a first lead-out portion end surface 14E and a second lead-out portion end surface 24E, which are positioned at end portions of the coil member 10.

A configuration of the magnetic powder is not limited. This structure may include a crystalline phase or may include an amorphous phase. Here, a crystalline material is defined as a material composed of a crystalline phase, an amorphous material is defined as a material composed of an amorphous phase, and a composite material is defined as a material composed of a crystalline phase and an amorphous phase. When a diffraction spectrum obtained by a general X-ray diffraction method includes sharp diffraction peaks that can identify a type of crystalline phase, the material includes a crystalline phase. In addition, when a diffraction spectrum obtained by a general X-ray diffraction method includes broad peaks indicating an amorphous phase, the material includes an amorphous phase. Further, when a DSC curve obtained by differential scanning calorimetry includes a peak indicating crystallization, that is, heat generation accompanying a phase change from an amorphous phase to a crystalline phase, the material also includes an amorphous phase.

A material system of the magnetic powder is not limited. Specific examples of crystalline materials include Fe—Si—Cr-based alloys, Fe—Ni-based alloys, Fe—Co-based alloys, Fe—V-based alloys, Fe—Al-based alloys, Fe—Si-based alloys, Fe—Si—Al-based alloys, pure iron, and ferrite. As powder of pure iron, carbonyl iron powder is preferable. Specific examples of amorphous materials include Fe—Si—B-based alloys, Fe—P—C-based alloys, and Co—Fe—Si—B-based alloys. Specific examples of composite materials include Fe—Zr-based alloys, Fe—Zr—B-based alloys, Fe—Si—B—Nb—Cu-based alloys, and Fe—Si—B—P—Cu-based alloys. When the magnetic powder is a metal powder containing Fe, a synergistic effect of improvement in magnetic characteristics is particularly large.

A chemical composition of the magnetic powder is not limited. For example, an Fe—Si—Cr-based alloy may include 1.0 to 10.0 mass % of Si, 1.0 to 10.0 mass % of Cr, and a balance consisting of Fe and impurities. In addition, for example, an Fe—Ni-based alloy may include 1.0 to 99.0 mass % of Ni, and a balance consisting of Fe and impurities. Further, for example, an Fe—P—C-based alloy may include 1.0 to 13.0 atomic % of P, 1.0 to 13.0 atomic % of C, and Fe and impurities. This Fe—P—C-based alloy may include, as optional elements, one or more selected from the group consisting of Ni, Sn, Cr, B, and Si. In this case, for example, an amount of Ni may be 0 to 10.0 atomic %, an amount of Sn may be 0 to 3.0 atomic %, an amount of Cr may be 0 to 6.0 atomic %, an amount of B may be 0 to 9.0 atomics, and an amount of Si may be 0 to 7.0 atomic %. An amount of Fe is preferably 65 atomic % or more. In addition, for example, an Fe—Si—B—Nb—Cu-based alloy may include 1.0 to 16.0 atomic % of Si, 1.0 to 15.0 atomic % of B, 0.50 to 5.0 atomic % of Nb, 0.50 to 5.0 atomic % of Cu, and a balance consisting of Fe and impurities. In this case, an amount of Fe is preferably 65 atomic % or more.

A shape of the magnetic powder is not limited. The magnetic powder may be spherical, elliptical, flaky, or may have an irregular shape. A manufacturing method for obtaining these shapes is also not limited.

A particle size distribution of the magnetic powder is not limited. The particle size distribution of the magnetic powder can be obtained, for example, by analyzing an image (secondary electron image) obtained by imaging a cut surface of the core main body portion 30 with a scanning electron microscope. For example, an average equivalent circle diameter of the magnetic powder may be 0.50 to 50.0 μm. A distribution of the equivalent circle diameter may include a plurality of peaks.

The magnetic powder may be subjected to surface insulation treatment. When surface insulation treatment is applied to the magnetic powder, insulation resistance of the core main body portion 30 is improved. A type of surface insulation treatment applied to the magnetic powder is not limited. Examples include phosphoric acid treatment, phosphate treatment, and oxidation treatment. The magnetic powder may have an insulating coating on surfaces of magnetic particles. This insulating coating may include at least one selected from the group consisting of Si, P, and B, and O (oxygen).

The magnetic powder may be a mixed material in which a plurality of powder materials are mixed. The magnetic powder is preferably a ferromagnetic material, and more preferably a soft magnetic material.

The core main body portion 30 may further include optional auxiliary materials. The optional auxiliary materials are, for example, binders and modifiers. The binder binds particles such as the magnetic powder contained in the core main body portion 30 to each other. The binder is preferably an insulating material in order to impart insulation resistance to the core main body portion 30.

The binder may be an organic material or an inorganic material. The organic material may be a resin material. Examples of the resin material include acrylic resins, silicone resins, epoxy resins, phenolic resins, urea resins, melamine resins, polyester resins, and the like. The inorganic material may be a glass-based material such as water glass. The binder may be a product of a reaction such as thermal decomposition, or may be a mixture of a plurality of materials.

The modifier, for example, improves flowability of powder or adjusts a curing rate of the binder. The modifier may be a glass-based material.

Dimensions of the core main body portion 30 are not limited. For example, a maximum dimension of the core main body portion 30 may be 3.2 mm or less.

### (External Electrodes)

As shown in FIG. 2, a first lead-out portion end surface 14E and a second lead-out portion end surface 24E, which are located at end portions of the coil member 10, are exposed from the core main body portion 30 at side surfaces of the core main body portion 30 arranged in the X1-X2 direction. A first external electrode 41 is provided so as to be in electrical contact with the first lead-out portion end surface 14E, and a second external electrode 42 is provided so as to be in electrical contact with the second lead-out portion end surface 24E.

As shown in FIG. 1, the first external electrode 41 includes a side surface portion 41a that covers a side surface of the core main body portion 30 on the X2 side in the X1-X2 direction, and a bottom surface portion 41b that is provided so as to cover a part of a bottom surface of the core main body portion 30 (surface on Z2 side in Z1-Z2 direction). The bottom surface portion 41b is a portion that faces a substrate during use. The second external electrode 42 includes a side surface portion 42a that covers a side surface of the core main body portion 30 on the X1 side in the X1-X2 direction, and a bottom surface portion 42b that is provided on the bottom surface of the core main body portion 30 so as to cover a part of the bottom surface while being spaced apart from the bottom surface portion 41b. The bottom surface portion 42b is also a portion that faces the substrate during use.

The positions of the first external electrode 41 and the second external electrode 42 are not limited to the positions described above. The first external electrode 41 and the second external electrode 42 may be formed so as to cover a part of a top surface of the core main body portion 30 (surface on Z1 side in Z1-Z2 direction). Alternatively, the first external electrode 41 and the second external electrode 42 may be provided only on a part of the bottom surface of the core main body portion 30 (surface on Z2 side in Z1-Z2 direction). In this case, the coil conductor portion 20 may include a connection conductor portion (not illustrated) that connects two end portions of the coil member 10 (first lead-out portion 14 and second lead-out portion 24) to the bottom surface of the core main body portion 30 through an interior of the core main body portion 30. In this case, the two end portions of the coil member 10 (first lead-out portion end surface 14E and second lead-out portion end surface 24E) may not be exposed at side surfaces of the core main body portion 30, and the connection conductor portion may be exposed at the bottom surface of the core main body portion 30.

Materials and configurations of the first external electrode 41 and the second external electrode 42 are not limited as long as they have appropriate conductivity. As one non-limiting example of the first external electrode 41 and the second external electrode 42, a layer having a structure of Cu plating/Ni plating/Sn plating from a side closer to a surface of the core main body portion 30 may be used. The first external electrode 41 and the second external electrode 42 may be formed of coating-type electrodes in which a conductive material such as silver is dispersed in a resin or the like. The first external electrode 41 and the second external electrode 42 may also be formed by a combination of plating and coating-type electrodes.

### (Outer Cover)

Insulating outer covers 50 and 60 are provided on a top surface of the core main body portion 30 (a surface on the Z1 side in the Z1-Z2 direction) and on side surfaces arranged in the Y1-Y2 direction, respectively. An insulating outer cover may also be provided on portions of the bottom surface of the core main body portion 30 where the bottom surface portions 41b and 42b are not provided.

Alternatively, the coil component 100 may not include the outer covers 50 and 60. The outer covers 50 and 60 can be formed at arbitrary positions on a surface of the core main body portion 30 depending on the purpose.

### (Electronic/Electric Device)

An electronic/electric device according to an embodiment of the present invention is an electronic/electric device in which the coil component 100 according to an embodiment of the present invention described above is mounted, and in which the coil component 100 is connected to a substrate by the first external electrode 41 and the second external electrode 42. Since the electronic/electric device according to an embodiment of the present invention has the coil component 100 according to an embodiment of the present invention mounted therein, miniaturization of the device is facilitated. In addition, even when a large current flows in the device or a high frequency is applied, malfunctions caused by degradation of the function of the coil component 100 or heat generation are unlikely to occur.

The embodiments and examples described above are provided to facilitate understanding of the present invention, and are not intended to limit the present invention. Accordingly, it is intended that all design modifications and equivalents belonging to the technical scope of the present invention are included in the scope of the present invention with respect to each element disclosed in the above embodiments.

The foregoing outlines the features of several embodiments, enabling those skilled in the art to fully appreciate the aspects of the present disclosure. Those skilled in the art should recognize that the present disclosure provides a foundation for designing or modifying other processes and structures to achieve substantially the same functions and/or substantially the same results as those of the embodiments introduced herein. Furthermore, such equivalent arrangements do not deviate from the spirit and scope of the present disclosure, and various changes, substitutions, and alterations may be made without so departing.

What is claimed is:

1. A coil component comprising:
a coil member including a spiral conductor portion having a plurality of turns with a central axis along a first direction, and a lead-out conductor portion extending in a second direction intersecting the first direction from an outer-side end part of the spiral conductor portion; and
a core main body portion that includes a magnetic powder and a binder, covers the spiral conductor portion and the lead-out conductor portion with an end surface of the lead-out conductor portion exposed therefrom,
wherein two side surfaces of the lead-out conductor portion along the second direction have a non-parallel portion when viewed in the first direction.

2. The coil component according to claim 1, wherein the lead-out conductor portion has a portion with a width becoming larger as approaching a boundary with the spiral conductor portion.

3. The coil component according to claim 1, wherein, when viewed in the first direction, a tangent line drawn from a midpoint of a line formed by the end surface of the lead-out conductor portion to an inner periphery of an outermost turn among the plurality of turns overlaps the outermost turn and the lead-out conductor portion between a contact point of the tangent line and the midpoint.

4. The coil component according to claim 1, wherein,
when viewed in the first direction, a tangent line is defined by drawing from a midpoint of the line formed by the end surface of the lead-out conductor portion to the inner periphery of the outermost turn among the plurality of turns, and
between a contact point of the tangent line and the midpoint, a clearance from the tangent line to a point, which is closest to the tangent line, on a line formed by an outer peripheral side surface of the outermost turn and a side surface of the lead-out conductor portion continuous with the outer peripheral side surface is not less than one quarter and not more than three quarters of a width passing through the contact point in the outermost turn.

5. The coil component according to claim 1, wherein,
when viewed in the first direction, a tangent line is defined by drawing from a midpoint of the line formed by the end surface of the lead-out conductor portion to the inner periphery of the outermost turn among the plurality of turns, and
when a portion of the inner periphery of the outermost turn from a contact point of the tangent line to an end on the lead-out conductor portion side is approximated by an arc,
a line segment connecting a center of the arc and the midpoint is parallel to a side surface of the lead-out conductor portion, which is connected to the inner periphery of the outermost turn.

6. The coil component according to claim 1, wherein,
when viewed in the first direction, a tangent line is defined by drawing from a midpoint of the line formed by the end surface of the lead-out conductor portion to the inner periphery of the outermost turn among the plurality of turns, and
a first line, which is obtained by connecting an outer peripheral side end point of a width passing through a contact point of the tangent line and an outer peripheral side end point of a line formed by the end surface of the lead-out conductor portion, includes a portion positioned on an inner peripheral side relative to an outer periphery of the outermost turn.

7. The coil component according to claim 6, wherein,
when viewed in the first direction, a portion, which is positioned on an outer peripheral side relative to the first line, of a line formed by an outer peripheral side surface of the outermost turn and a side surface of the lead-out conductor portion continuous with the outer peripheral side surface is defined as an outer peripheral side portion, and
a clearance from the first line to a point, which is farthest to the first line, in the outer peripheral side portion is not less than one tenth of the width passing through the contact point in the outermost turn.

8. The coil component according to claim 1, wherein,
when viewed in the first direction, a tangent line is defined by drawing from a midpoint of a line formed by the end surface of the lead-out conductor portion to an inner periphery of an outermost turn positioned at an outermost periphery among the plurality of turns, and
in a line formed by an outer peripheral side surface of the outermost turn, a portion, which is closer to the end surface of the lead-out conductor portion than an outer peripheral side end point of a width passing through a contact point of the tangent line, has a shape approximated by an arc having a center on an inner peripheral side.

9. The coil component according to claim 1, wherein,
when viewed in the first direction, the outer-side end part extends along a width including a point, at which a virtual conductive center line obtained by connecting midpoints of widths of an outermost turn positioned at the outermost periphery among the plurality of turns and the lead-out conductor portion bends most, and
an outer peripheral side end point of a line formed by the outer-side end part overlaps with an outer peripheral side end point of the outermost turn on a line formed by the exposed end surface of the lead-out conductor portion.

10. The coil component according to claim 1, wherein,
when viewed in the first direction, a tangent line is defined by drawing from a midpoint of a line formed by the end surface of the lead-out conductor portion to an inner periphery of an outermost turn positioned at an outermost periphery among the plurality of turns, and
when a side surface of the lead-out conductor portion continuous with an outer peripheral side surface of the outermost turn is defined as a lead-out portion outer-side surface,
a point, which is closest to the tangent line, on a line formed by the outer peripheral side surface of the outermost turn and the lead-out portion outer-side surface overlaps with an outer peripheral side end point of the outermost turn on a line formed by the exposed end surface of the lead-out conductor portion.

11. The coil component according to claim 1, further comprising an external electrode provided on the core main body portion and electrically connected to the end surface of the lead-out conductor portion exposed from the core main body portion.

12. An electronic/electric device, in which the coil component according to claim 11 is mounted, wherein the coil component is connected to a substrate by the external electrode.
